(19) United States
(12) Patent Application Publication
(10) Pub. No.: US 2015/0325339 A1
(43) Pub. Date: Nov. 12, 2015

(54) Manufacturing Process of Superconductors with Reduced Critical Current Dependence under Axial Mechanical Strain

(71) Applicant: BRUKER BIOSPIN AG, Faellanden (CH)

(72) Inventor: Bernd Seeber, Geneve (CH)

(21) Appl. No.: 14/670,433

(22) Filed: Mar. 27, 2015

(30) Foreign Application Priority Data
Apr. 3, 2014 (DE) 10 2014 206 429.5

(51) Int. Cl. H01B 13/02; H01B 12/02

(52) U.S. Cl. CPC H01B 13/02; H01B 12/02

(57) ABSTRACT

A method for manufacturing a superconducting wire having a plurality of filaments, at least some of which are twisted around the wire axis, characterized in that the superconducting filaments are twisted so that the majority of filaments comes to lie at an angle of twist greater than 50° with respect to the wire axis. It is possible in this way, using simple technical means, to significantly reduce the great dependence of the critical current of a superconducting wire at high magnetic fields as a function of an axial strain. In addition, with a corresponding arrangement of the superconducting filaments, the critical current dependence of a superconducting wire at high magnetic fields as a function of an axial strain can be largely canceled.

This application claims Paris convention priority from DE 10 2014 206 429.5 filed Apr. 3, 2014 the entire disclosure of which is hereby incorporated by reference.

### BACKGROUND OF THE INVENTION

The invention relates to a manufacturing process for a superconducting wire having a plurality of filaments, at least some of which are twisted around the wire axis.

Such a method is known per se from reference [4], for example.

The invention describes a method for manufacturing a multicore superconducting wire, in which the twist of the superconducting filaments is arranged around an optimal twist length in a targeted manner. Twist length is understood to be the length over which the filaments inside a wire carry out a rotation of 360°. An optimal twist length means that in superconductors in which the critical current is highly sensitive to axial mechanical strain, the strain sensitivity can be reduced. This is of major technological importance because it reduces the wire lengths required for the magnet design (and also the cost accordingly).

Nb₃Sn can be mentioned as an example of the industrial superconductor used most commonly today for generating extremely high magnetic fields. FIG. 1 shows the critical current at 4.2 Kelvin as a function of the applied axial stain (see reference [1]). At a magnetic field of 7 Tesla, the axial strain dependence of the critical current is relatively low. However, with an increase in the magnetic field, the sensitivity of the critical current increases greatly with the strain. In the case of 19 Tesla, for example, there is a reversible increase in the critical current of approximately 100% (!) at a low strain, followed by a subsequent reduction approaching zero.

The superconducting wire in a magnet is exposed to high electromagnetic forces (Lorentz forces). The critical current of the superconductor changes because of these forces and the resulting strain. As FIG. 1 shows, the change in the critical current is particularly pronounced at high magnetic fields. A magnet manufacturer must take this behavior into account in the design and construction of a magnet.

The present invention now makes it possible to make the critical current largely independent of the axial strain through a special manufacturing process. To do so, it is necessary to go into the physical principles of this behavior in somewhat greater detail.

In a recently published study, the crystallographic lattice constant of Nb₃Sn inside a wire was successfully measured as a function of strain at 4.2 Kelvin (see reference [2]). The use of a high-energy x-ray radiation such as that available with the European Synchrotron Radiation Facility (ESRF) in Grenoble was crucial for this experiment. An Nb₃Sn wire manufactured by using the known internal tin process (Oxford Instruments Superconducting Technology) was investigated. The wire has a diameter of 0.81 mm and the superconducting filaments are twisted (twist length=15 mm). The stress-strain curve of the wire was recorded at 4.2 Kelvin and the lattice constants of the materials present in the conductor, in particular Nb₃Sn, were measured in situ. In addition, the same conductor was provided with a steel jacket (AISI 316L) to study the influence of thermal compression (axially and radially). In an independent experiment, the critical current was measured as a function of strain. FIG. 2 summarizes the results.

At zero strain, the cubic Nb₃Sn lattice is distorted: a reduction of the lattice constant in the axial direction (compression) and an increase in the radial direction is observed. With an increase in the axial strain, the distortion of the cubic lattice is reduced linearly and disappears at a certain strain value. In the case of the Nb₃Sn conductor investigated here, the external strain for a cubic (nondistorted) Nb₃Sn lattice is 0.22% (FIG. 2A). If the same conductor is surrounded with a steel jacket, the distortion of the cubic Nb₃Sn lattice is greater at zero strain. The reason for this is that the thermal contraction of the steel jacket exceeds that of the Nb₃Sn conductor in cooling the superconductor to 4.2 Kelvin, which results in additional compression. An axial strain of 0.53% is needed to cancel the lattice distortion (FIG. 2B).

In both cases (with and without the steel jacket), the critical current reaches its maximum value with a nondistorted, i.e., cubic, Nb₃Sn lattice. The observed shift in the maximum critical current with respect to the purely cubic Nb₃Sn lattice (+0.03%) is due to the twist of the superconducting filaments. Because of this twist, not all of the current-carrying filaments are parallel to the external strain. For this reason, the strain of nonparallel filaments is reduced, which leads to a change in the critical current.

Particularly noteworthy is the influence of a steel jacket, which contributes toward additional distortion of Nb₃Sn and therefore reduces the critical current from 67 A (maximum value) to 10 A (!) at zero strain. This behavior is reversible in the shown strain interval up to 1%.

For the magnet manufacturer, the behavior of the superconducting wire is as shown in FIGS. 1 and 2 (prior art). To better utilize the current-carrying capability of a superconducting wire versus magnetic field, solenoid magnets are subdivided into sections. The section exposed to the highest magnetic field is wound with a superconductor of a larger cross section. With a decline in the magnetic field strength, the superconductor cross section can be reduced (see reference [3]).

However, there are also applications in which it is difficult, if not entirely impossible, to subdivide the magnet into sections (e.g., multipole magnets for high-energy physics, magnets for fusion reactors). With respect to the current-carrying capability, the superconducting wire is then fully utilized only in a small part of the magnet and is overdimensioned in other parts. With larger magnetic systems, the enormous electromagnetic forces also play an important role. The windings of the magnet must then be protected by a mechanical reinforcement.

Twisting of the superconducting filaments is likewise known from the prior art. This is necessary in order to keep the superconductor stable with a magnetic field that changes over time (e.g., when charging or discharging a magnetic coil). From a physical standpoint, an electric voltage, which causes coupling currents between the filaments, occurs in a magnetic field that changes over time. Heating occurs because these coupling currents flow over the electrically conductive, but not superconducting matrix. Twisting the filaments is one possibility for reducing such coupling currents. In simplified terms, the induced voltages are compensated over a twist length (rotation of filament by 360°). The critical twist length can be determined by means of the following equation (see reference [4]):

$${I}_{c} = \sqrt{\frac{2 ρ {J}_{c} d}{{μ}_{0} d H / d t}}$$

where I_{c} is the critical twist length, ρ is the resistivity of the normally conducting matrix, J_{c} is the current density of the superconductor, d is the diameter of the superconducting filament and μ₀dH/dt is the change over time in a magnetic field, applied at a right angle to the superconducting wire. For an Nb₃Sn superconductor, this yields a critical twist length of 0.566 m and 0.057 m with ρ=4·10⁻⁸ Ωm (copper-tin bronze), J_{c}=8·10⁸ A/m², d=5·10⁻⁶ m and μ₀dH/dt between 10⁻³ and 10⁻¹ T/s.

The critical twist length is an upper limit, which should be considerably lower in practice. The TF-ITER conductor can be mentioned as a practical example (TF-ITER=Toroidal Field-International Thermonuclear Experimental Reactor). At a wire diameter of 0.81 mm, the twist length is 15 mm. This corresponds approximately to one-fourth of the critical twist length cited above at a rate of field change of 10⁻¹ T/s.

The maximum twist angle of the filaments with respect to the wire axis for the reduction of coupling currents between the filaments mentioned above, can be determined according to the following equation:

$$tan θ = \frac{π D}{{I}_{p}}$$

where D is the wire diameter (or better yet, the diameter on which the outer filaments inside the wire are situated) and Iₚ is the actual twist length. In practice, this now yields maximum twist angles up to approximately 10°-15°. An upper limit is a superconductor for a 50/60 Hz alternating current application, in which twist angles up to 25° occur (see reference [5]).

There is now a possibility for significantly improving the strain dependence of the critical current of an Nb₃Sn superconductor, which is the subject matter of the present invention. To this end, it is not only advisable to investigate the distortion of the Nb₃Sn lattice in the axial and radial directions. The synchrotron radiation experiment cited above allows the measurement of Nb₃Sn lattice constants in any direction (see reference [2]). One example of this is illustrated in FIG. 3, where the distortion (strain) in the Nb₃Sn lattice was measured in various directions after the process of cooling to 4.2 Kelvin, i.e., without any strain acting from the outside. The axial compression of Nb₃Sn (−0.53%) in the wire axis in the case of a steel jacket is noteworthy. Without a steel jacket, the compression amounts to −0.22%. Since the superconductor filaments are arranged mostly in parallel with the wire axis (because of the twist, there is a maximum deviation of 10°), the critical current is influenced. At 4.2 Kelvin and a magnetic field of 19 Tesla, the critical current is 51 A without the steel jacket and 10 A (!) with the steel jacket (also shown in FIGS. 2A and 2B).

The angle dependence of the Nb₃Sn lattice strain can be modeled (see reference [6]). Assuming the lattice strain in the axial wire direction εₐₓ₀ and in the radial wire direction ε_{rad0} are known by measurement, this can be calculated at other angles θ:

ε(θ)=\sqrt{(1+εₐₓ₀)² sin²θ(1+ε_{radθ})² cos²θ}−1

As shown in FIG. 3, the lattice strains determined experimentally are described very well by this function.

The angle dependence of the lattice strain can now be calculated as a function of the axial strain. FIGS. 4A and 4B were calculated using the lattice strain in the axial wire direction εₐₓ₀ and that in the radial wire direction ε_{rad0} found in FIG. 2. The following findings can be obtained in this way:

For an Nb₃Sn wire without a steel jacket, the distortion of the cubic Nb₃Sn lattice is canceled when applying an external axial strain of 0.22% (see also FIG. 2A). In other words, the lattice strain in all directions is zero. In the case of an Nb₃Sn wire with a steel jacket, an external axial strain of 0.53% is needed to obtain a strictly cubic Nb₃Sn lattice (see also FIG. 2B). The fact that there is no lattice distortion at a certain angle, regardless of the external axial strain, is novel now. This angle with respect to the wire axis is 58°±2° for an Nb₃Sn wire without a steel jacket (FIG. 4A) and is 55°±5° for a wire with a steel jacket (FIG. 4B).

As FIG. 2 shows, the critical current has a maximum value for a purely cubic Nb₃Sn lattice, i.e., without distortion. If the fact that the filaments of an Nb₃Sn wire are twisted is taken into account, this then yields the possibility of adjusting the twist length, so that most of the filaments come to lie in the vicinity of 58°. The critical current dependence on an external axial strain can thus be greatly reduced. This is precisely the subject matter of the present invention.

The object of the present invention in comparison with the prior art is to present a method of the type defined in the introduction, in which the strong critical current dependence of a superconducting wire at high magnetic fields as a function of axial strain can be greatly reduced using the simplest possible technical means. In addition, the invention should result in mostly cancelling the critical current dependence of a superconducting wire at high magnetic fields as a function of an axial strain with a suitable arrangement of the superconducting filaments.

### SUMMARY OF THE INVENTION

This objective is achieved in a surprisingly simple manner and by using technical means that are readily available by a modification of a method having the features defined in the introduction, characterized in that the superconducting filaments are twisted, so that the majority of the filaments come to lie at a twist angle greater than 50° with respect to the wire axis.

The goal of the invention, as defined above, is achieved by the fact that filaments lying at an angle of more than 50° to the wire axis undergo almost no distortion of the Nb₃Sn lattice, regardless of the axial strain, and therefore have a maximum critical current (see also FIG. 2 and FIGS. 4A and 4B). Consequently, the critical current of the overall conductor depends only slightly on the axial strain when using the method according to the invention.

With the help of the method modified according to the invention, the critical current dependence in high magnetic fields on axial strain can be influenced for the first time in particular in comparison with the most proximate prior art (see references [1], [7] and [8]). With the method according to the invention, the critical current can be kept at its maximum value almost regardless of the axial strain. This has the great advantage that much less superconducting wire is needed for a magnet with an equivalent magnetic field. Fewer windings are necessary due to the higher critical current. In addition to an economic advantage, i.e., lower costs, a magnet can therefore also be designed to be much more compact. A compact design reduces the electromagnetic forces acting on the superconductor, which is also a substantial advantage in the conception and construction of superconducting magnet systems.

Most particularly preferred is a variant of the method according to the invention, which is characterized in that the superconducting filaments are twisted so that the majority of filaments come to lie at an angle of twist of 58°, preferably between 50° and 65°, in particular between 56° and 60° with respect to the wire axis. Therefore the distortion of the crystallographic lattice of the current-carrying filaments becomes independent of an external axial strain (see also FIG. 4A). Such a behavior is advantageous for a maximum critical current of the overall conductor, which is then almost independent of external axial strain (see also FIG. 2). The superconducting wire is thus utilized much better in a magnet, which is equivalent to reducing the required wire length and therefore the cost in particular.

Another advantageous variant of the method according to the invention is characterized in that Nb₃Sn or a material having a similar behavior of the critical current as a function of an axial strain like that of Nb₃Sn is selected. This also makes the distortion of the crystallographic lattice of the current-carrying filaments independent of an external axial strain (see also FIG. 4A). Such a behavior is advantageous for a maximum critical current, which is then almost independent of an external axial strain (see also FIG. 2). The superconducting wire is therefore utilized much better in a magnet, which is in turn equivalent to reducing the required wire length and cost.

A process variant in which the superconducting wire is reinforced mechanically, either externally or internally, is also preferred. In the case of an external reinforcement of an Nb₃Sn superconductor with stainless steel (AISI 316L), the distortion of the crystallographic lattice of the current-carrying filaments at an angle of twist of 55° is independent of an external axial strain (see also FIG. 4B). Such a behavior is in turn advantageous for a maximum critical current, which is then almost independent of an external axial strain (see also FIG. 2), so the superconducting wire is utilized much better in a magnet, which is equivalent to a reduction in the required wire length and cost. The optimum angle of twist is derived from the reinforcement/superconductor cross-sectional ratio and from whether the reinforcement comes from the outside or the inside.

One class of variants of the method according to the invention is characterized in that the superconducting filaments are arranged in a ring and therefore the portion of filaments having the required angle of twist relative to the wire axis is increased. Again with this process variant, the distortion in the crystallographic lattice of the current-carrying filaments becomes independent of an external axial strain (see also FIG. 4A). Such a behavior is in turn advantageous for a maximum critical current, which is then almost independent of an external axial strain (see also FIG. 2). The superconducting wire is therefore utilized much better in a magnet, which is equivalent to reducing the required wire length and the cost.

In an alternative class of process variants, the superconducting filaments are bundled, and the twist within a bundle is designed so that the required angle range of the angle of twist of the filaments relative to the wire axis is satisfied. Thus the distortion of the crystallographic lattice of the current-carrying filaments also becomes independent of an external axial strain, with the advantages already described above.

A method according to the invention, in which the twist operation is performed following the manufacture of the wire, is also advantageous.

Another preferred process variant is characterized in that after a first wire twisting operation, the wire diameter is reduced, so that the required diameter tolerance is satisfied.

It is also advantageous if, after a second wire twist operation, the wire diameter is reduced, so that the required diameter tolerance is satisfied.

Finally, a preferred variant of the method according to the invention is characterized in that one or more recovery annealings are performed, so that larger angles of twist are achieved.

Additional advantages of the invention are derived from the description and the drawing. Likewise, the features according to the invention, mentioned above and those yet to be mentioned below, may be used either individually alone or several in any combination. The embodiments shown and described here are not to be understood as a final list but instead have more of an exemplary character for the description of the invention.

The invention is illustrated in the drawings and is explained in greater detail on the basis of exemplary embodiments.

### BRIEF DESCRIPTION OF THE DRAWING

FIG. 1 shows the critical current dependence at 4.2 Kelvin with an Nb₃Sn superconductor as a function of an axial strain and of the magnetic field;

FIG. 2 illustrates the critical current (▪) at 4.2 Kelvin and 19 Tesla of an Nb₃Sn superconductor as a function of an axial strain. At the same time the lattice constant of the Nb₃Sn in the axial () and radial directions (∘) are shown. The behavior in FIG. 2A corresponds to an Nb₃Sn superconductor without a steel jacket and in FIG. 2B with a steel jacket;

FIG. 3 shows the distortion (lattice strain) of the Nb₃Sn lattice as a function of the angle to the wire axis after the cooling process to 4.2 K and without axial strain. The arrows indicate the direction of the wire axis. The measurement points are based on an Nb₃Sn superconductor without a steel jacket (∘) and with a steel jacket (□), and the solid lines show the good agreement with model calculations;

FIGS. 4A and 4B show the calculated distortion (lattice strain) of the Nb₃Sn lattice as a function of the angle to the wire axis and the axial strain. The arrows indicate the direction of the wire axis. The behavior in FIG. 4A corresponds to that of an Nb₃Sn superconductor without a steel jacket and with the axial strain as follows: •••••••••• 0%, - - - - - - 0.1%, —————— 0.22%, — — — — 0.3%, —•—•— 0.4% and [symbol] 0.5%. FIG. 4B shows the same Nb₃Sn superconductor with a steel jacket and with an axial strain of •••••••••• 0%, [symbol] 0.3%, [symbol] 0.53%, [symbol] 0.7% and [symbol] 1.0%;

FIG. 5 illustrates the possibility of the arrangement of the superconductor Nb₃Sn filaments in a ring-shaped zone (2) around a wire core (1), which increases the portion of filaments having the required optimal angle of twist; and

FIG. 6 illustrates the possibility of arranging the superconducting Nb₃Sn filaments in bundles (4) around a wire core (3). This yields an additional possibility to increase the portion of filaments having the required optimal angle of twist.

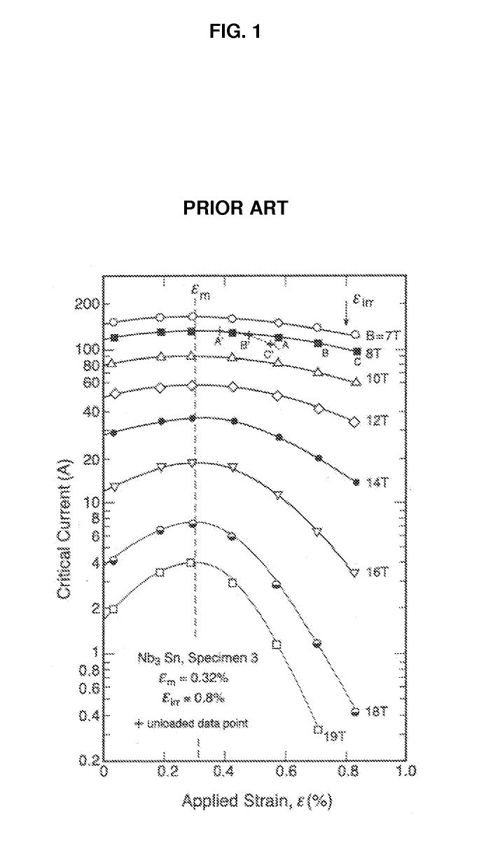

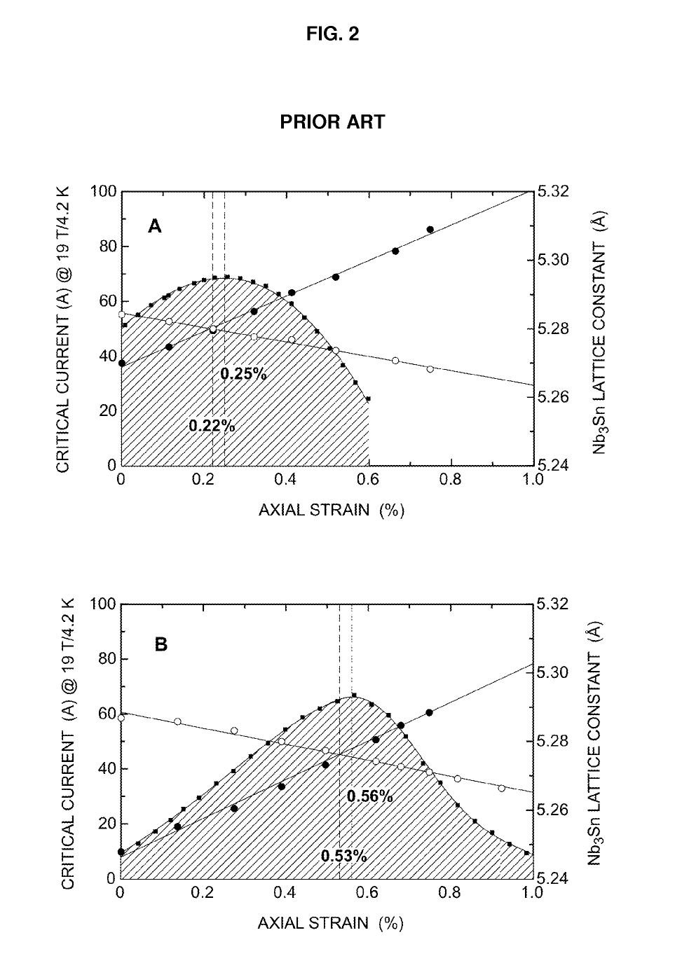

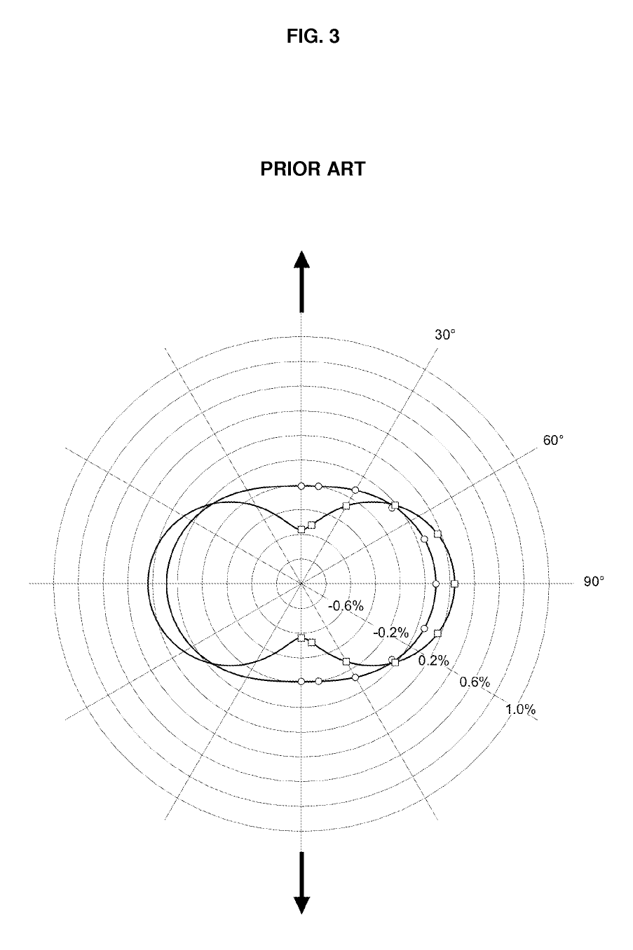

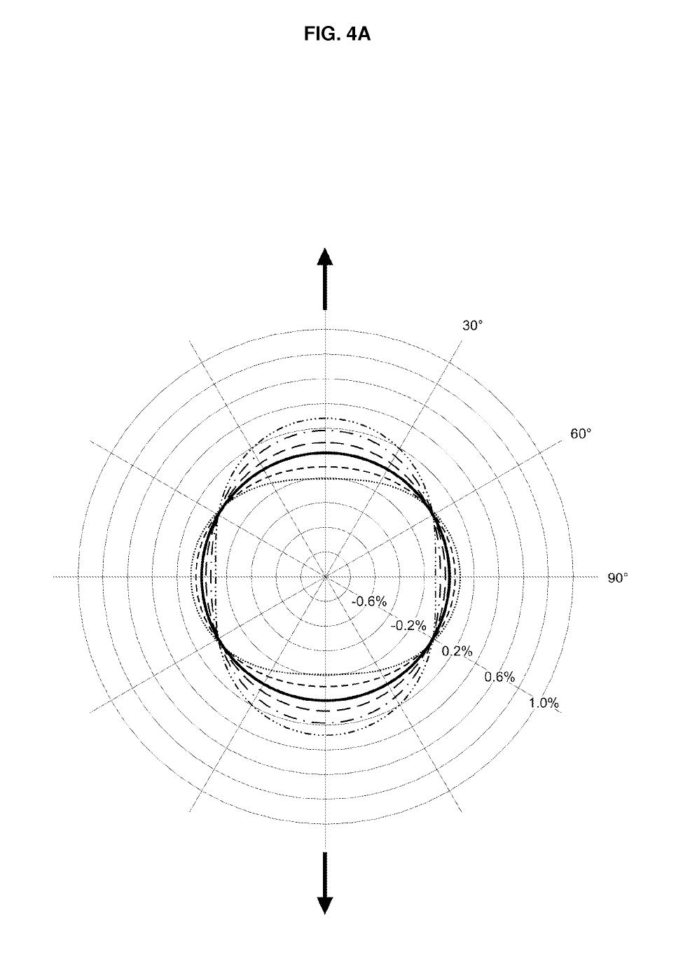

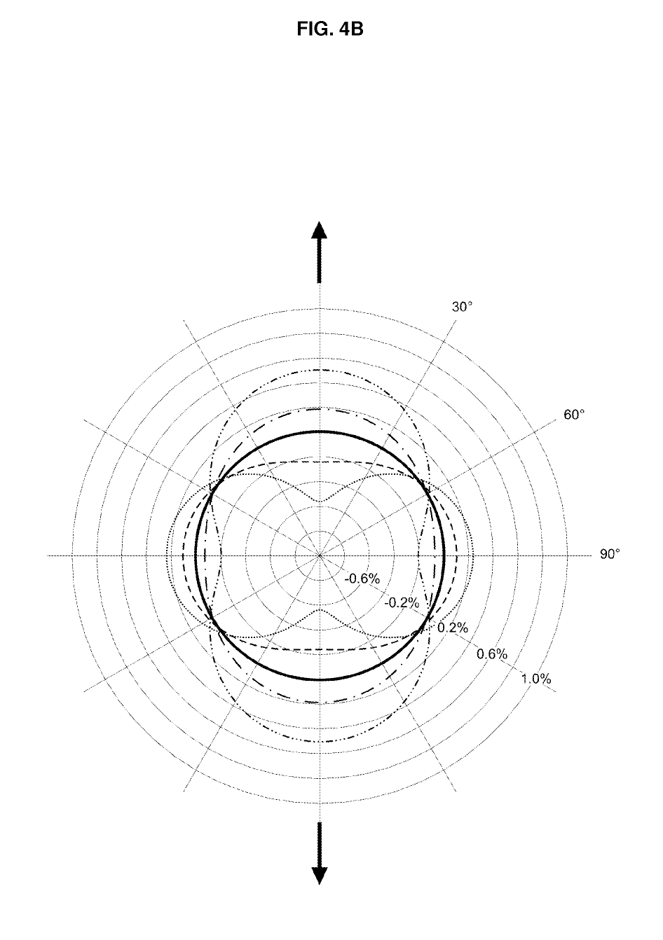

### DESCRIPTION OF THE PREFERRED EMBODIMENT

The method according to the invention can be described in greater detail below on the basis of examples.

### Example 1

Manufacture of an Nb₃Sn wire, namely regardless of the manufacturing process (bronze process, internal tin process or PIT process) takes place as usual. At the end of the manufacturing process, the filaments are twisted. The twist length is adjusted so that the majority of filaments comes to lie at an angle of approximately 58° to the wire axis.

### Example 2

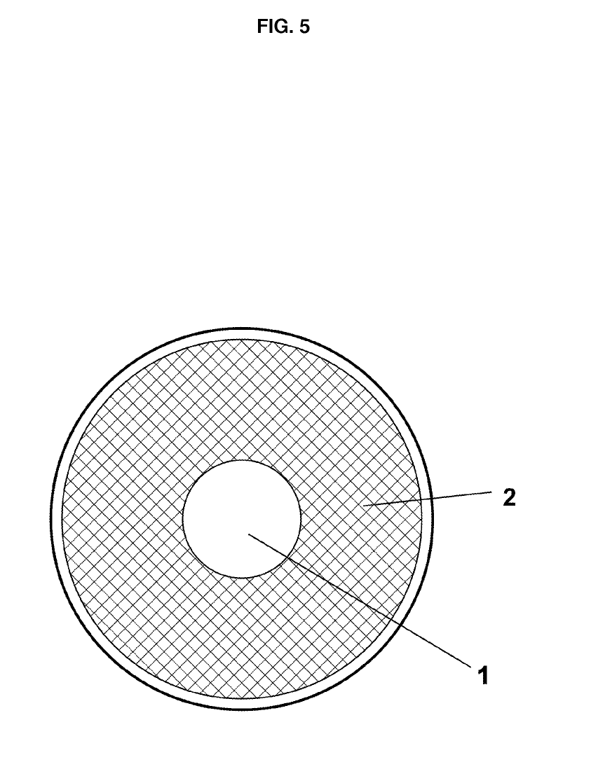

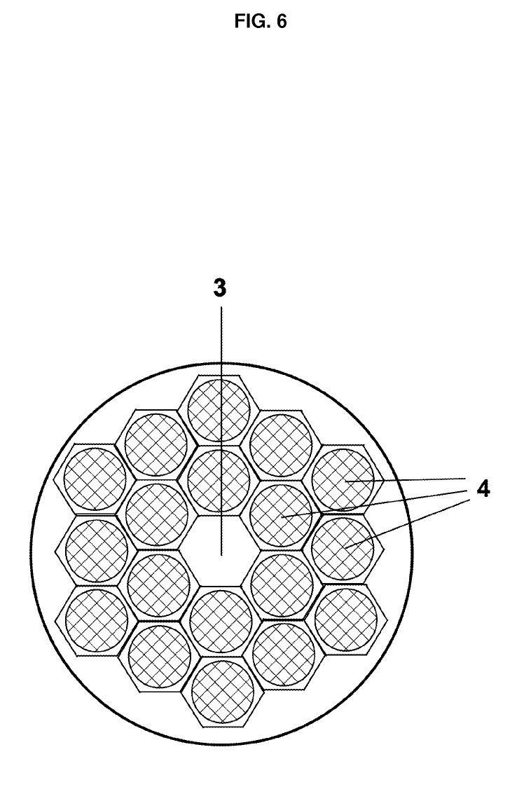

Since the filaments at the center of the wire are not twisted in the case of Example 1, the concept of the wire can be modified. In this case, the filaments are arranged in a concentric zone around the wire axis (FIG. 5). Then the Nb₃Sn wire is manufactured, namely regardless of the manufacturing process (bronze process, internal tin process or PIT process) as usual. At the end of the manufacturing process, the filaments are twisted. The twist length is adjusted so that the majority of filaments comes to lie at an angle of approximately 58° to the wire axis.

### Example 3

Another possibility of achieving an angle of twist of approximately 58° to the wire axis is to arrange the filaments into bundles. In this case, an individual bundle is twisted to the extent that the required angle of twist of approximately 58° is established after the end of the manufacturing process.

### Example 4

Twisting the filaments by an angle of 58° to the wire axis may lead to a variation in the wire diameter. One variant of the process consists of the fact that the diameter of the wire is calibrated by one or more wire drawing steps after an initial twist at a small angle of twist (less than 58°). Then the twisting process is continued.

### Example 5

The twisting process may result in an embrittlement of the wire. In this case, one or more strain-relief annealings must be performed during the twisting process.

### REFERENCE LIST

[1] J. W. Ekin, “Strain scaling law for flux pinning in practical superconductors. Part 1: Basic relationship and application to Nb₃Sn conductors”, Cryogenics, Volume 20, 1980, p. 613
[2] L. Muzzi et al., “Direct observation of Nb₃Sn lattice deformation by high energy x-ray diffraction in internal-tin wires subject to mechanical loads at 4.2 K”, Supercond. Sci. Technol., Volume 25, 2012, p. 05006
[3] M. N. Wilson, “Superconducting magnets”, Oxford University Press, 1983, p. 23
[4] M. N. Wilson et al., “Experimental and theoretical studies of filamentary superconducting composites. I. Basic ideas and theory”, J. Phys. 3D, 1970, p. 1526
[5] P. Dubots et al., “NbTi wires with ultra-fine filaments for 50-60 Hz use: influence of the filament diameter upon losses”, IEEE Trans. on Mag. Volume MAG-21, 1985, p. 177
[6] S. Awaji et al., “Angular dependence of residual strain in CuNb/(Nb, Ti)₃Sn wires”, Supercond. Sci. Technol. Volume 23, 2010, p. 105010
[7] A. Godeke, “A review of the properties of Nb₃Sn and their variation with A15 composition, morphology and strain state”, Supercond. Sci. Technol., Volume 19, 2006, p. R77
[8] J. W. Ekin, “Unified scaling law for flux pinning in practical superconductors: I. Separability postulate, raw scaling data and parameterization at moderate strains”, Supercond. Sci. Technol., Volume 23, 2010, p. 7

I claim:

1. A method for manufacturing a superconducting wire having a plurality of superconducting filaments, the method comprising the step of:
twisting the superconducting filaments around a wire axis such that a majority of the filaments comes to lie at an angle of twist greater than 50° with respect to the wire axis.

2. The method of claim 1, wherein the superconducting filaments are twisted, so that the majority of filaments comes to lie at an angle of twist of 60°, between 55° and 65° or between 57° and 59° with respect to the wire axis.

3. The method of claim 1, wherein Nb₃Sn or a material having a similar behavior of critical current as a function of axial strain as Nb₃Sn, is selected as a material of the superconducting wire.

4. The method of claim 1, wherein the superconducting wire is reinforced mechanically, is reinforced mechanically internally or is reinforced mechanically externally.

5. The method of claim 1, wherein the superconducting filaments are arranged in a form of a ring, and a portion of filaments satisfying a required angle of twist relative to the wire axis is increased.

6. The method of claim 1, wherein the superconducting filaments are bundled and a twist within a bundle is designed, so that a required angle range of the filaments relative to the wire axis is satisfied.

7. The method of claim 1, wherein a twisting process is carried out following manufacture of the wire.

8. The method of claim 1, wherein a wire diameter is reduced after a first wire twisting operation, so that a required diameter tolerance is satisfied.

9. The method of claim 1, wherein a wire diameter is reduced after a second wire twisting operation, so that a required diameter tolerance is satisfied.

10. The method of claim 1, wherein one or more recovery annealings are performed, so that larger angles of twist are achieved.
